(19) United States
(12) Patent Application Publication
(10) Pub. No.: US 2012/0296577 A1
(43) Pub. Date: Nov. 22, 2012

(54) MAGNETOELASTIC FORCE SENSORS, TRANSDUCERS, METHODS, AND SYSTEMS FOR ASSESSING BENDING STRESS

(75) Inventors: Ivan J. Garshelis, Dalton, MA (US); Stijn P. L. Tollens, Cambridge, CA (US)

(73) Assignee: MAGCANICA, INC., San Diego, CA (US)

(21) Appl. No.: 13/521,731

(22) PCT Filed: Jan. 11, 2011
(86) PCT No.: PCT/US11/20892

§ 371 Date: Jul. 11, 2012

Related U.S. Application Data
(60) Provisional application No. 61/294,071, filed on Jan. 11, 2010.

(51) Int. Cl. G01L 1/12; G06F 19/00

(52) U.S. Cl. 702/42; 73/779

(57) ABSTRACT

A new type of magnetoelastic device for sensing force is described. It comprises of two elements: a circumferentially magnetized member comprised of magnetoelastically active material mounted as a beam and loaded by the force to be sensed, and a magnetic field sensor mounted at or near the member's surface, preferentially at or near a longitudinal location where the bending moment is maximum and at a circumferential location where the bending stress is zero. Flexural loading causes a variation of the circumferential magnetization with angular position. This variation is the source of free poles, the field from which is a measure of the applied force. Testing demonstrates that the field intensity is a linear analog of the experienced bending stress over a significant range of applied push and pull forces.

### FIELD OF THE INVENTION

This invention concerns sensors and transducers for assessing bending stresses and measuring force on magnetized members and objects magnetized members are attached to, as well as systems and methods for making and using the same.

### BACKGROUND OF THE INVENTION

1. Introduction

The following description includes information that may be useful in understanding the present invention. It is not an admission that any such information is prior art, or relevant, to the presently claimed inventions, or that any publication specifically or implicitly referenced is prior art.

2. Background

Force sensors based on magnetomechanical effects typically derive their output signals from variation of a magnetic property of a magnetoelastically active “core” member with the stress caused by the force of interest. Thus, stress-induced changes in peak induction', coercivity, or permeability' have been suggested for sensing force. Operation of such sensors obviously requires a source of cyclically varying exciting fields, the frequency, amplitude, and wave shape of which affect sensor performance Also, since the measured property changes from some non-zero quiescent value in response to the force, the force-to-property “transfer functions” of these types of sensors typically include an offset term, any inconstancy of which can impair the ultimate sensor accuracy. The present invention provides an inherently zero quiescent value for zero input in force.

3. Definitions

Before describing the invention in detail, several terms used in the context of the present invention will be defined. In addition to these terms, others are defined elsewhere in the specification, as necessary. Unless otherwise expressly defined herein, terms of art used in this specification will have their art-recognized meanings.

An “array” refers to an organized grouping of two or more similar or identical components.

The terms “measure”, “measuring”, “measurement” and the like refer not only to quantitative measurement of a particular variable, for example, a rate of change in or of force, but also to qualitative and semi-quantitative measurements. Accordingly, “measurement” also includes detection, meaning that merely detecting a change, without quantification, constitutes measurement.

A “patentable” process, machine, or article of manufacture according to the invention means that the subject matter satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically exclude the unpatentable embodiment(s). Also, the claims appended hereto are to be interpreted both to provide the broadest reasonable scope, as well as to preserve their validity. Furthermore, if one or more of the statutory requirements for patentability are amended or if the standards change for assessing whether a particular statutory requirement for patentability is satisfied from the time this application is filed or issues as a patent to a time the validity of one or more of the appended claims is questioned, the claims are to be interpreted in a way that (1) preserves their validity and (2) provides the broadest reasonable interpretation under the circumstances.

The term “operably associated” refers to an operable association between two or more components or elements. For example, components of electrical circuits, devices, and systems are operably associated. In other words, an operable association does not require direct physical connection between specified components.

A “plurality” means more than one.

### SUMMARY OF THE INVENTION

A new type of force sensor, having no excitation source and wherein in the absence of applied force the measured quantity is inherently zero, is described. The new sensor is a true transducer, in that it converts a portion of the mechanical work associated with the application of force to an elastically deformable member into a magnetic field, the intensity of which is linearly proportional to the applied force and whose polarity is reversed between push and pull forces. In its elementary form (FIG. 1), the new transducer consists of a thin wall tube of circumferentially remanently magnetized, magnetoelastically active material, supported as a beam, wherein the force (P) to be sensed is applied transverse to the tube's longitudinal axis. A magnetic field sensor (Hall effect device, magnetoresistor flux gate, etc.) oriented to sense radial fields, is mounted on or near the outside (inside) surface of the tube, on the diametral plane normal to P. Operation of this sensor will be shown to derive from subtle consequences of the distinctive stress distribution associated with flexure⁴, combined with the spin vector orientation distribution which characterizes the beam's remanent⁵ magnetization.

One object of this invention thus concerns patentable sensors and devices that can detect, measure, sense, or otherwise assess force(s) experienced by an object attached to a magnetized member carrying or subjected to a bending stress. In general, a sensor according to the invention comprises at least one sense element (e.g., a field sensor) configured to output an electrical signal (for example, a voltage) indicative of a bending stress experienced by a mechanical or structural component, i.e., a “member”, carrying or subjected to the bending stress. The sense element is capable of detecting, sensing, or otherwise responding to bending stresses due to changes in one or more magnetic parameters of one or more magnetized regions of the member positioned proximate to the sense element(s).

The member transmitting a force and carrying or subjected to a bending stress and sense element are proximately positioned so that the sense element can detect, sense, or otherwise respond to a change in a magnetic parameter of the member's magnetized region as a result of a bending stress applied to or otherwise experienced by the member. In preferred embodiments, the one or more sensors are part of system that also includes at least one of a processor operatively associated with the sense element and configured to process and/or interpret signals output from the sense element to determine the bending stress experienced by the member and a memory operatively associated with the sense element and configured to store one or more data elements in the signal output from the sense element.

The member carrying or subjected to a bending stress itself is magnetized in one or more regions; alternatively, or in addition, the member may include one or more rings or other parts rigidly mounted thereto that are magnetized over part or all of their length or circumference. Preferably, the magnetized region(s) of the member is(are) substantially circumferentially magnetized. In preferred embodiments, the member carrying or subjected to a bending stress is itself magnetized in at least one region, i.e., the magnetized region(s), and at least one sense element according to the invention is disposed for sensing a change in the magnetic parameter(s) to be sensed with respect to the magnetized region. In particularly preferred embodiments, the member comprises a plurality of magnetized regions, which preferably are spaced from each other, and at least two of which are optionally magnetized in opposite directions.

When assembled into a functional sensing device, the sensor(s) according to the invention are preferably disposed in a housing adapted for the particular application. The housing preferably is configured to position the sense element(s) in spaced relation and proximate to the magnetized region of a mechanical or structural member. As will be appreciated, wiring, circuitry, control logic, and an energy source (e.g., a power supply such as a battery) will be included, with the understanding that the particular components and configuration of a given assemblage will differ depending on the particular application. Components suitable for data logging and/or transmitting telemetry may also be included, if desired. Additionally, as those in the art will appreciate, a sensor may also include a plurality of sense elements. Also, in some embodiments, an array comprised of a plurality of sensors according to the invention, may also be deployed. Similarly, in some applications a plurality of different types of sensors, one or more of which is a sensor according to the invention, may be deployed, separately or as an integrated sensor array. Other sensors include, without limitation, torque sensors, rates of change of torque sensors, speed sensors, accelerometers, and thermocouples.

Another object of the invention relates to methods for detecting, measuring, sensing, or otherwise assessing bending stresses applied to or experienced by members with which sensors of the invention are deployed. Such methods comprise exposing a member having one or more magnetized regions to a bending stress and using one or more sense elements according to the invention that has/have been positioned proximate to the magnetized region(s) of the member to detect, measure, sense, or otherwise assess force resulting from bending stresses experienced by the member. The resulting data can be used for many purposes associated with the monitoring and/or control of various types of machinery and equipment, including, without limitation, those containing one or more moving parts or structural components designed to experience some degree of compliance (e.g., flexure, bending, or other elastic deformation) while in operation.

Other features and advantages of the invention will be apparent from the following drawings, detailed description, and appended claims.

### BRIEF DESCRIPTION OF THE DRAWINGS

FIG. 1 illustrates the functional elements of a force transducer according to the invention. Panel (a) shows a tubular member supported as a beam, loaded by the force of interest, P. Panel (b) is a cross section indicating circumferential magnetization M_{c}, position angle α, and certain geometric features. FS indicates alternative field sensor location. Panel (c) shows a distribution of stresses on a cross section.

FIG. 2 shows the effect of tensile stress (a) and compressive stress (b) on magnetization orientations within a vector pair.

FIG. 3 shows quiescent spin vector orientation distributions around the member's circumference, together with the resulting M_{c} (panel (a)). Panel (b) shows variation of bending stress with angular position, while panel (c) shows variations of the same member shown in panel (a) under stress depicted in panel (b).

FIG. 4 plots variation of M_{c} with position angle for vector pairs having original orientations indicated. Also shown, as a dashed bold line, is the variation of M_{c} with position angle for a member comprising a tubular beam in which the magnetization is characterized by equal volumes of each vector pair.

FIG. 5 shows the variation of peak amplitude of M_{c}, “A”, with S.

FIG. 6 plots variation in radial field intensity with α from α 18% maraging steel transducer with ψₚₑₐₖ=125 MPa.

FIG. 7 plots experimental transducer transfer functions of the materials indicated (i.e., maraging steel and nickel).

As those in the art will appreciate, the following detailed description describes certain preferred embodiments of the invention in detail, and is thus only representative and does not depict the actual scope of the invention. Before describing the present invention in detail, it is understood that the invention is not limited to the particular aspects and embodiments described, as these may vary. It is also to be understood that the terminology used herein is for the purpose of describing particular embodiments only, and is not intended to limit the scope of the invention defined by the appended claims.

### DETAILED DESCRIPTION

### A. Theory

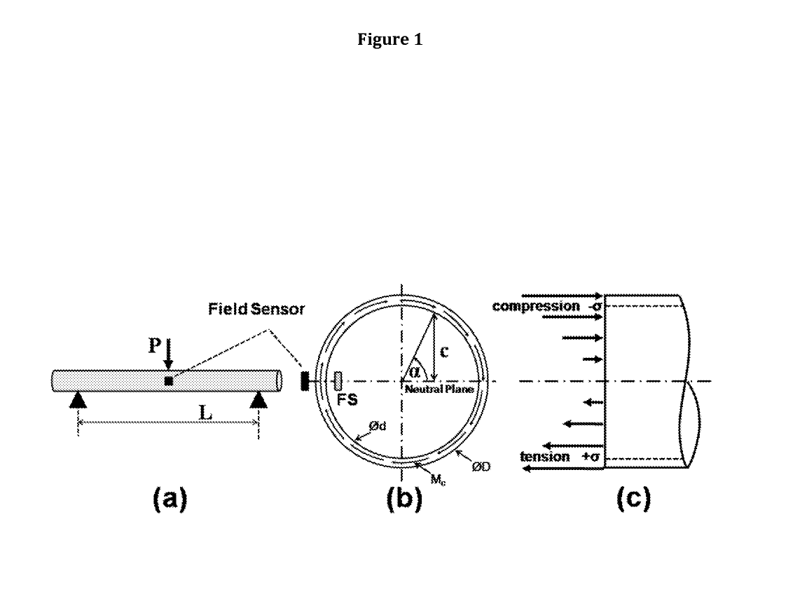

For the member, shown as a beam in FIG. 1(a), resting on two supports, distance L apart, the bending moment B, at the midpoint where P is applied, is found as B=PL/4. Equilibrium demands that B at any location be resisted by the moment of the longitudinal (i.e., “normal”) stresses within the beam material and that the net force from such stresses be zero. These requirements are met in beams with cross sections having mirror image symmetry about a center line normal to both P and L, e.g., round tubular cross sections, by the symmetrical distribution of tensile (+ψ) and compressive (−ψ) stresses indicated in FIG. 1(c). The stress magnitude at distance c (FIG. 1(b)) from the beam's central plane (the “neutral axis”) is found as⁴: ψ=Bc/I, where I is the moment of inertia of the cross section about its diameter. For a tubular section with outside diameter D and inside diameter d, I=π (D⁴−d⁴)/64. For a thin tube, wherein D≈d, c may be expressed with adequate precision in terms of the position angle α, as c=D sin α/2. In terms of the force P (with downward directed forces considered negative), the geometric features indicated, and the configuration of FIG. 1(a), the normal stress within the tube material can be found from:

$$σ = \frac{8 PLD}{π ( {D}^{4} - {d}^{4} )} sin α \qquad ( 1 )$$

Prior to the application of any forces, the tubular beam will have been substantially circumferentially magnetized, either by a field of saturating intensity from a short duration unipolar current through an axially concentric conductor, or by rotation on its axis in the fringing field of a suitable magnet⁶. In ideal, stress, and defect free polycrystalline materials, the magnetization in each (non-interacting) crystallite will lie along the easy axis nearest to the circumferential direction. In samples comprised of randomly oriented cubic crystals these easy axes lie within a solid angle of 110°. In real materials, the local fields arising at grain boundaries and defects, as well as the anisotropy associated with microstresses, generally act to further widen this orientation distribution. In the tubular element being considered it is only necessary to recognize that the local magnetization orientation varies over a wide angular range. For a crystal wherein the saturation magnetization, Mₛ, is oriented at some angle θ to the circumferential direction, the circumferential component M_{c}=Mₛ cos θ. Within the entire tube, M_{c}=Mₛ c̅o̅s̅ θ̅, the volume weighted average of all the local magnetization orientations. As magnetized, M_{c} is substantially circumferentially uniform.

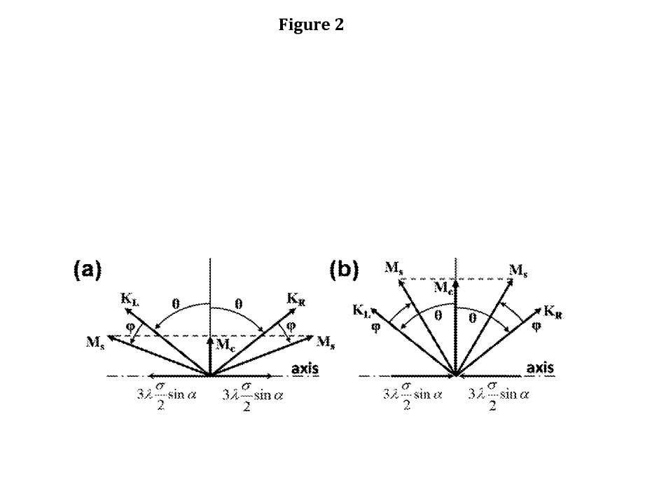

A simplified analysis, wherein the magnetostriction, λ, of the beam material is considered isotropic and the crystal anisotropy is approximated by a uniaxial constant, K, is sufficient to demonstrate the operating principle of the sensor. It is convenient to consider the distribution of spin vector orientations within the magnetized beam to be comprised of an equivalent distribution of vector pairs, the members of each being symmetrical in orientation and representative of equal volumes. It is also assumed that there are equal volumes of all of the orientations comprising the distribution. Within pairs, and hence within the entire beam, the axial and radial components of the saturation magnetization, Mₛ, initially sum to zero, and, following from their symmetry, continue to sum to zero however their orientations be altered by flexural stress. The circumferential components of the individual members of any pair remain always equal to each other and contribute additively to M_{c}. One such vector pair, having quiescent orientations θ_{L} and θ_{R}, as determined by K_{L} and K_{R} respectively, is illustrated in FIG. 2. The stress anisotropy, 3λψ/2, arising with the application of P acts to rotate the Mₛ vectors away from K through an angle φ. For materials wherein λ>0, tensile stress will rotate the vectors towards the tube axis as shown in FIG. 2(a), whereas under compressive stress they will rotate towards the circumferential direction as shown in FIG. 2(b). The angle φ can be found by minimizing the sum of the crystal and magnetoelastic anisotropies. A normalized (against K) stress anisotropy, S, can be defined and expressed in terms of P and geometric features from (1) as:

$$\begin{matrix}S = \frac{3 λσ}{2 K} \\ = \frac{3 λ ( 8 PLD ) sin α}{2 π ( {D}^{4} - {d}^{4} ) K} \\ = \frac{12 λ PLD sin α}{π ( {D}^{4} - {d}^{4} ) K}\end{matrix} \qquad ( 2 a )$$

or as a variation expressing S in terms of B rather than P, applicable to any beam configuration (e.g., cantilever, rigid supports, non central loading, etc.):

$$S = \frac{48 λ BD sin α}{π ( {D}^{4} - {d}^{4} ) K} \qquad ( 2 b )$$

(2a) and (2b) can each be expressed as S=Sₚₑₐₖ sin α.

In any case the total magnetic energy density, E, is found as:

E=Kₛᵢₙ²φ+SK sin²(π/2−(φ+θ)) (3)

Although the sensor develops a magnetic field under the action of P, no magnetostatic energy term associated with this field is included in Equation (3), above.

From ∂E/∂φ=0, the following equation can be derived:

$$φ = \frac{1}{2} {tan}^{- 1} ( \frac{S sin 2 θ}{1 - S cos 2 θ} ) \qquad ( 4 )$$

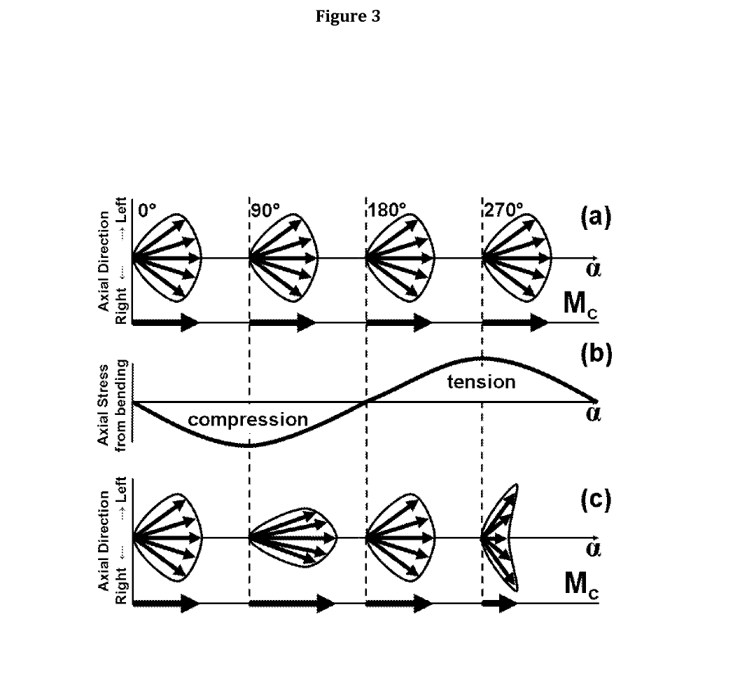

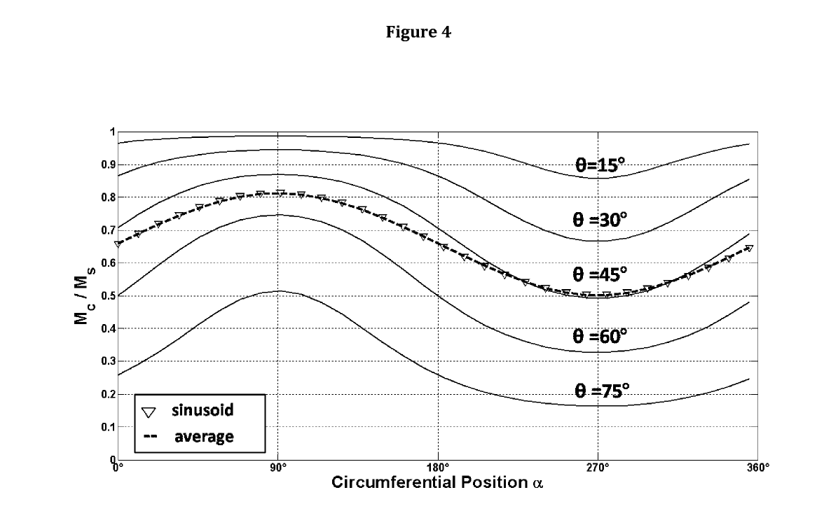

The (quiescently uniform) substantially circumferential component of magnetization, M_{c}=Mₛ c̅o̅s̅ θ̅ is seen to be changed to M_{c}=Mₛ c̅o̅s̅ (̅θ̅+̅φ̅)̅ by the application of P. Since φ is dependent on S, and S varies with α, the consequence of applying P (in a configuration producing bending moments), is that M_{c} is no longer circumferentially uniform. The effects of bending stress on vector distributions and the consequential effects on M_{c} are graphically depicted in FIG. 3. FIG. 4 shows the effect of Sₚₑₐₖ=0.5 on the variation of M_{c} with α for vector pairs having initial vector orientations of θ=15°, 30°, 45°, 60°, and 75°. The asymmetrical effects of tensile and compressive stress are clearly apparent in these plots. By contrast, however, the plot (bold dashed line) showing the variation of M_{c} in a tubular beam wherein the magnetization is characterized by a distribution containing all 5 of the indicated vector pairs is seen to approach a perfect sinusoid, a tendency found to grow even more with distributions populated by wider and more finely divided orientations. This close approximation to sinusoidal variation diminishes rapidly as Sₚₑₐₖ increases above 1.

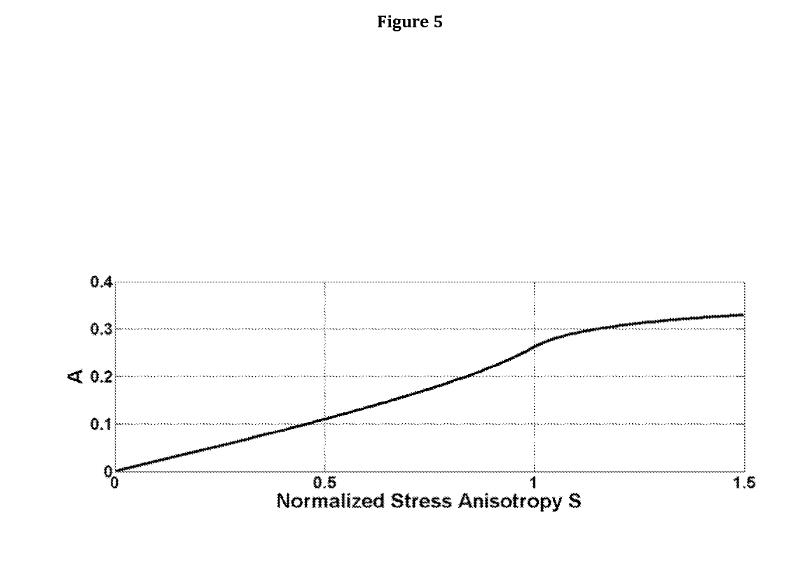

The peak amplitudes, A, of the positional variation of M_{c} with 0≦Sₚₑₐₖ≦1.5 for orientation distributions from 1° to 89° are plotted in FIG. 5. The linearity falls off rapidly for values of Sₚₑₐₖ>1, reflective of saturation in the rotation of many of the vector orientations. Within the linear range where M_{c}=A sin α (closely), dM_{c}/dα=A cos α. Since ∇·M_{c} ∝dM_{c}/dα, hypothetical “free” poles with surface density ρ∝A cos α appear on the surface of the beam. Maximum absolute values of ρ thus occur at α=0° and 180° and have opposite polarities at these positions. The model thus predicts that a magnetic field will arise when P is applied. The field will have peak intensities on the beam's neutral plane and be off opposite polarities on diametrically opposite sides. The intensity of this field will expectedly vary directly with A, hence, in the linear range of Sₚₑₐₖ<1, directly with Sₚₑₐₖ and therefore with P. The field polarity reverses between push and pull forces.

### B. Experimental

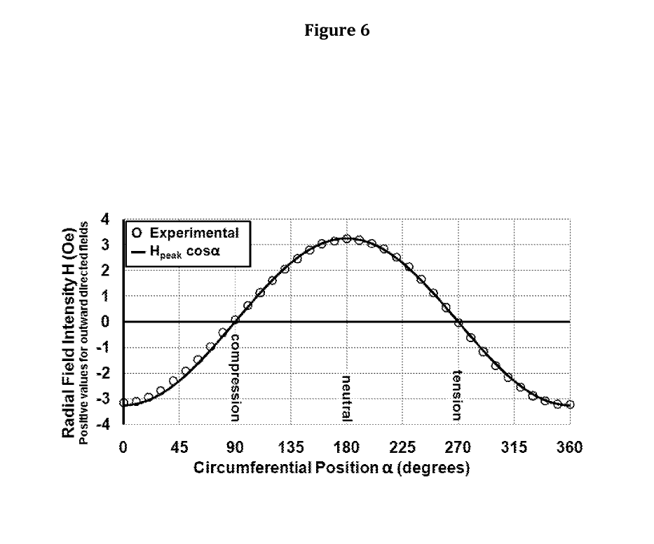

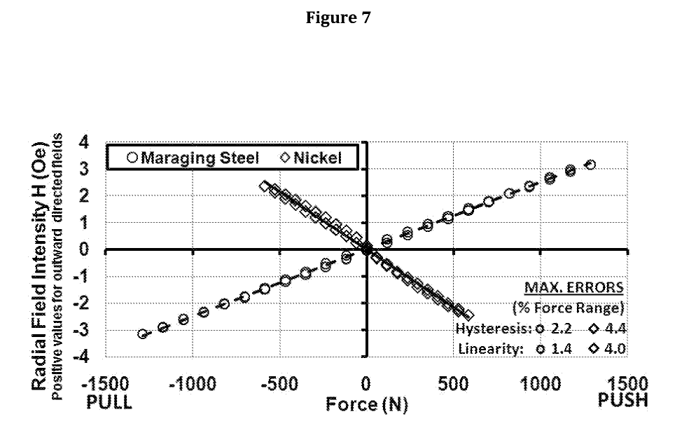

Two experimental transducers, having tubular beams 60 mm long with D=15.9 mm and d=12.7 mm, were constructed, one of 18% Ni maraging steel, centered, and attached thereto with silver solder to a 12.7 mm diameter, 300 mm long ISI Type 303 stainless steel rod, and the other of cold drawn Nickel 200 attached with anaerobic adhesive to an identical rod. The tubes were circumferentially polarized by ˜1000 A, 1 ms current pulses conducted axially through the rods. An Allegro type 3615 Hall effect IC, oriented to detect radial fields, was cemented to the surface at the center of each tube. Each assembly, in turn, was installed into a four point bending apparatus which allowed for applying a measured force normal to the rod axis, at any selected angular position of the field sensor, thereby effectively varying α. This manner of loading establishes a constant B over the full tube length, thereby eliminating any possible effects of bending moment gradients. The measured field, H, at every 10° for 0≦α≦360° for P=1288 N corresponding to peak tensile and compressive stresses on the tube surface of 125 MPa is plotted in FIG. 6 for the maraging steel sample. Also plotted is Hₚₑₐₖ cos α, which, by its obvious close concurrence with the data, confirms a key prediction of the analytical model. Transfer function data from both experimental assemblies, for both push and pull forces are plotted in FIG. 7, as are their linear regression lines. The excellent linearity of the plots, the polarity reversal between push and pull forces and between λ of opposite signs, further support this understanding. Hysteresis is seen as the major source of linearity error.

### C. Conclusions

Force transducers using a novel combination of mechanical, magnetoelastic, and magnetostatic principles have been described. Measurements of the operational characteristics of experimental devices support the theoretical basis of the analytical model. The high quality of these transfer functions clearly supports this approach. Scaling laws, applicable materials, configurational variations, stability over time, effects of temperature, and other environmental conditions are among the factors those in the art will consider when adapting this invention for various applications in devices configured to exploit the underlying phenomena described herein.

### D. Applications

The present invention has many applications. For example, it can be used in helicopter rotor load measurement, wherein the main rotor is typically loaded in multiple ways, including by torque, bending, and tension/compression. The present invention will also find application in the context of wind turbine rotor shafts and other associated driveline components, wherein once again a variety of loadings (e.g., torque, bending, and/or tension/compression) can be experienced by the components. The present invention can additionally be applied to structures, machines, devices, and components wherein combined multidirectional loading is present, such as robot joints, rotating machines, linear actuators, automotive suspension components, civil engineering structures (e.g., bridges, buildings, dams, etc.), et cetera. The present invention can also be utilized in conjunction with a variety of industrial devices and machines instrumented with load cells; such devices include hydraulic and electric actuators, scales, weighing stations, aircraft structures, and pressing and molding equipment, among others.

Depending upon the particular application, the sensors of the invention can also be integrated with other sensor types, including, for example, torque sensors, rate of change of torque sensors, speed sensors, position sensors, pressure sensors, accelerometers, and thermocouples. Particularly preferred torque sensors include those described in U.S. Pat. Nos. 6,553,847, 6,490,934, 6,260,423, 6,145,387, 6,047,605, 5,708,216, 5,591,925, 5,520,059, 5,465,627, 5,367,257, 5,351,555, 5,195,377, and 5,052,232. Particularly preferred rate of change torque sensors include those described in U.S. Pat. No. 7,832,289.

### Bibliography

¹ D. Son and J. Sievert, IEEE Trans. Magn., Vol. 26, 1990, pp. 2017-2019.
² I. J. Garshelis, J. Appl. Phys. 73 (10), May 1993, pp. 5629-5631.

### ³ T. A. Baudendistel and M. L. Turner, IEEE Sensors Journal, Vol. 7, No. 2, 2007, pp. 245-250.

⁴ STRESSES IN BEAMS. David Roylance. Department of Materials Science and Engineering. Massachusetts Institute of Technology. Cambridge, Mass. 02139 (21 Nov. 2001), accessible as a webpage at: web.mit.edu/course/3/3.11/www/modules/bstress.pdf

### ⁵ Chikazumi, Soshin, Physics of Magnetism, New York: Wiley, 1964, pp. 249-251.

⁶ I. J. Garshelis and S. P. L. Tollens, IEEE Trans. Magn. Vol. 41, No. 10, 2005, pp. 2796-2798.

All of the articles and methods disclosed and claimed herein can be made and executed without undue experimentation in light of the present disclosure. While the articles and methods of this invention have been described in terms of preferred embodiments, it will be apparent to those of skill in the art that variations may be applied to the articles and methods without departing from the spirit and scope of the invention. All such variations and equivalents apparent to those skilled in the art, whether now existing or later developed, are deemed to be within the spirit and scope of the invention as defined by the appended claims. It will also be appreciated that computer-based embodiments of the instant invention can be implemented using any suitable hardware and software.

All patents, patent applications, and publications mentioned in the specification are indicative of the levels of those of ordinary skill in the art to which the invention pertains. All patents, patent applications, and publications are herein incorporated by reference in their entirety for all purposes and to the same extent as if each individual publication was specifically and individually indicated to be incorporated by reference in its entirety for any and all purposes.

The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A sensor to detect a force experienced by a member, comprising:
a. a sense element configured to output a signal indicative of a force experienced by a member carrying or subjected to a bending stress, wherein the sense element is capable of detecting a magnetic parameter or a change therein of a magnetized region of the member positioned proximate to the sense element in response to a bending stress or change therein experienced by the member; and at least one of
b. a processor operatively associated with the sense element and configured to process signals output from the sense element to determine bending stress and/or force experienced by the member; and/or
c. a memory operatively associated with the sense element and configured to store one or more data elements in the signal output from the sense element.

2. A sensor according to claim 1 further comprising a power supply, optionally comprised of at least one battery, operatively associated with the sensor.

3. A sensor according to claim 1, wherein the sense element is disposed in a housing configured for positioning the sense element in spaced relation and proximate to the magnetized region of the member.

4. A sensor according to claim 1, wherein the signal is a voltage.

5. A sensor according to claim 1, wherein the magnetized region of the member is circumferentially magnetized.

6. A sensor according to claim 1, wherein the magnetized region of the member comprises a magnetized band, optionally a plurality of magnetized regions, at least two of which are optionally magnetized in opposite directions.

7. A sensor according to claim 1, wherein the member comprises a plurality of spaced magnetized bands.

8. An assembly comprising a sensor according to claim 1 operably associated about a magnetized region of the member.

9. An assembly according to claim 8, wherein the sense element is disposed in a housing configured to position the sense element in spaced relation and proximate to the magnetized region(s) of the member.

10. An assembly according to claim 9 further comprising a power supply, processor, and memory operatively associated with the sensor.

11. A sensor according to claim 1 operably associated with one or more of a torque sensor and a rate of change of torque sensor.

12. A method of sensing a force experienced by a member, comprising:
a. subjecting a member having a magnetized region to a force or bending stress; and
b. using a sensor according to claim 1 that has been positioned proximate to the magnetized region of the member to sense a force or bending stress experienced by the member.
